(19) United States
(12) Patent Application Publication
(10) Pub. No.: US 2015/0266589 A1
(43) Pub. Date: Sep. 24, 2015

(54) AIRCRAFT SYSTEMS AND METHODS WITH GREEN FUEL TANKS

(71) Applicant: HONEYWELL INTERNATIONAL INC., Morristown, NJ (US)

(72) Inventors: Eric Blumer, Scottsdale, AZ (US); Mukund Acharya, Scottsdale, AZ (US); Audie Mak, San Diego, CA (US); Mario Scaini, Phoenix, AZ (US); Bijan F. Hagh, Newport Beach, CA (US)

(73) Assignee: HONEYWELL INTERNATIONAL INC., Morristown, NJ (US)

(21) Appl. No.: 14/223,428

(22) Filed: Mar. 24, 2014

(51) Int. Cl. B64D 37/00; H01M 8/06; B64D 37/34; B64D 41/00; B64D 37/02; B64D 37/30

(52) U.S. Cl. CPC B64D 37/00; B64D 37/02; B64D 37/30; B64D 37/34; B64D 41/00; H01M 8/0625; H01M 2250/20

(57) ABSTRACT

An aircraft system includes a main fuel tank configured to house primary fuel and a green fuel tank configured to house green fuel. The mixing apparatus is configured to mix the primary fuel and the green fuel to result in a predetermined ratio of mixed fuel. A controller selectively commands a first amount of primary fuel and a second amount of green fuel to result in the predetermined ratio of mixed fuel. The main aircraft engine is configured to operate, in a first main engine mode, with the primary fuel from the main fuel tank and to operate, in a second main engine mode, with the mixed fuel from the mixing apparatus based on commands from the controller. The auxiliary power source is configured to operate with at least a portion of the green fuel from the green fuel tank based on commands from the controller.

### TECHNICAL FIELD

The present invention generally relates to aircraft systems and methods, and more particularly relates to aircraft systems and methods with green fuel tanks.

### BACKGROUND

Aircraft engines are used for a number of purposes, including propulsion and/or driving various other components such as, for example, generators, compressors, and pumps, to thereby supply electrical, pneumatic, and/or hydraulic power. Generally, the aircraft includes a primary or main engine for propulsion during flight, and the aircraft includes an auxiliary power unit (APU) to supply electrical, pneumatic, and/or hydraulic power to aircraft systems, particularly on the ground. Conventionally, both types of engines use the same type of fuel, such as Jet-A fuel.

It is generally advantageous to operate the engines in a more efficient manner, including from the perspectives of cost, fuel volume, emissions, and operational conditions. For example, conventional fuels may result in higher pollution emissions than alternative or green fuels. However, such green fuels may be a challenge to implement given the current state of operational and government requirements.

Accordingly, it is desirable to provide aircraft systems and methods with a more effective use of green fuel. Furthermore, other desirable features and characteristics of the present invention will become apparent from the subsequent detailed description of the invention and the appended claims, taken in conjunction with the accompanying drawings and this background of the invention.

### BRIEF SUMMARY

In accordance with an exemplary embodiment, an aircraft system is provided. The system includes a main fuel tank configured to house primary fuel and a green fuel tank configured to house green fuel. The system further includes a mixing apparatus coupled to the main fuel tank and the green fuel tank. The mixing apparatus is configured to mix the primary fuel and the green fuel to result in a predetermined ratio of mixed fuel. The system further includes a controller configured to selectively command a first amount of primary fuel from the main fuel tank and a second amount of green fuel from the green fuel tank to result in the predetermined ratio of mixed fuel. The system further includes a main aircraft engine coupled to the controller, the main fuel tank, and the mixing apparatus. The main aircraft engine is configured to operate, in a first main engine mode, with the primary fuel from the main fuel tank and to operate, in a second main engine mode, with the mixed fuel from the mixing apparatus based on commands from the controller. The system further includes an auxiliary power source coupled to the controller and the green fuel tank. The auxiliary power source is configured to operate with at least a portion of the green fuel from the green fuel tank based on commands from the controller.

In accordance with an exemplary embodiment, an aircraft fuel system includes a main fuel tank configured to house primary fuel and a green fuel tank configured to house green fuel. The aircraft fuel system further includes a mixing apparatus coupled to the main fuel tank and the green fuel tank. The mixing apparatus is configured to mix the primary fuel and the green fuel to result in a predetermined ratio of mixed fuel. The aircraft fuel system further includes a controller configured to selectively command a first amount of primary fuel from the main fuel tank and a second amount of green fuel from the green fuel tank to result in the predetermined ratio of mixed fuel.

### BRIEF DESCRIPTION OF THE DRAWINGS

The present invention will hereinafter be described in conjunction with the following drawing figures, wherein like numerals denote like elements, and

FIG. 1 is a schematic block diagram of an aircraft system according to an exemplary embodiment;

FIG. 2 is a schematic block diagram of an aircraft system according to another exemplary embodiment;

FIG. 3 is a schematic diagram of a fuel tank arrangement according to an exemplary embodiment; and

FIG. 4 is a schematic representation of a user interface of an aircraft system according to an exemplary embodiment.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

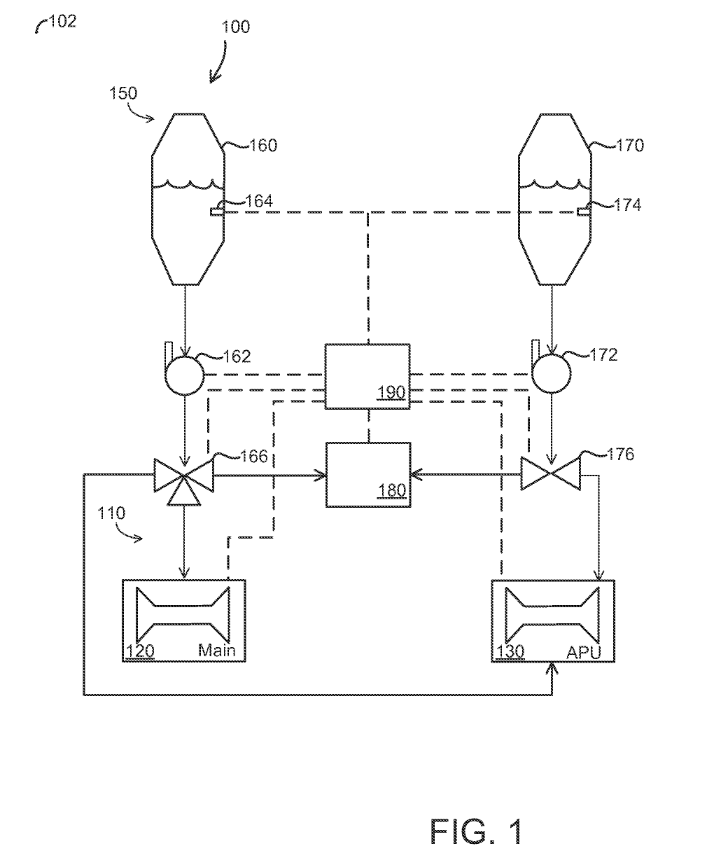

FIG. 1 is a schematic diagram of an aircraft system 100 in accordance with an exemplary embodiment. Generally, the aircraft system 100 includes one or more power sources 110 and one or more fuel sources 150 housed on an aircraft 102. The aircraft system 100 further includes one or more controllers 190 for operating the power sources 110 and the fuel sources 150 based on predetermined instructions stored in memory and executed by a processor and/or from commands from a pilot or operators via a user interface 192 or other aircraft systems. The controller 190 may be, for example, a FADEC. As described in greater detail below, the power sources 110 operate with fuel supplied by the fuel sources 150 based on commands from the controller 190.

As shown, the power sources 110 include a main engine 120 and an auxiliary power unit (APU) 130. The main engine 120 may be any suitable type of engine that provides main propulsion for the aircraft 102, including turboprop engines, turboshaft engines, turbojet, and turbofan engines. As is generally known, the main engine 120 is configured to receive fuel, mix the fuel with air, ignite the mixture, and extract the energy from the resulting combustion gases. The APU 130 may be any suitable type of engine that provides auxiliary power for the aircraft 102, including electrical, pneumatic, and/or hydraulic power to various aircraft systems, particularly on the ground. The APU 130 may be, for example, a turboshaft engine that receives fuel, mixes the fuel with air, ignites the mixture, and extracts the energy from the resulting combustion gases. Additional details about the fuel utilized by the main engine 120 and the APU 130 are provided below.

The fuel sources 150 include a main fuel tank 160, a green fuel tank 170, and a mixing apparatus 180. The fuel sources 150 may also be considered to include a main fuel pump 162, a main fuel sensor 164, a main fuel valve 166, a green fuel pump 172, a green fuel sensor 174, and a green fuel valve 176. Although not shown, additional pumps, valves, sensors, and the like may be provided for operating the fuel sources 150 according to the functions described below. The components of the fuel sources 150 will be introduced below prior to a more detailed description of operation of the fuel sources 150 within the aircraft system 100.

As the name suggests, the main fuel tank 160 houses primary or main fuel. Generally, the main fuel tank 160 may be any suitable structure for containing the primary fuel. The main fuel tank 160 may be composed of metal or any other suitable material to inhibit or prevent leaks. In practice, the main fuel tank 160 may be a number of fuel tanks dedicated to primary fuel. The term “primary fuel” may be used to reference traditional types of aircraft engine fuel, including kerosene based Jet A and Jet A-1 fuels and other types of fuels for commercial aviation and jet propellant JP-8 and JP-5 fuels for military jet engines. The main fuel pump 162 functions to remove primary fuel from the main fuel tank 160 based on commands from the controller 190. The main fuel sensor 164 functions to measure or derive the amount of fuel in the main fuel tank 160 and provide the amount to the controller 190 and/or the pilot via the user interface 192. The main fuel valve 166 is configured to direct the fuel from the main fuel tank 160 to the main fuel tank 160, the APU 170, or the mixing apparatus 180 based on commands from the controller 190, as discussed in greater detail below.

The green fuel tank 170 houses green fuel. Generally, the green fuel tank 170 may be any suitable structure for containing the green fuel. The green fuel tank 170 may be composed of metal or any other suitable material to inhibit or prevent leaks. In practice, the green fuel tank 170 may be any number of fuel tanks dedicated to green fuel. As used herein, the term “green fuel” may be used to reference various types of biofuels, including green diesel and ultra-low sulfur fuels. In one exemplary embodiment, the term “green fuel” may be defined according to government regulation or industry standard. As an example, ASTM D7566-11 is a specification for aviation turbine fuel containing synthesized hydrocarbons. Such synthesized hydrocarbons may include, as examples, bio-derived synthetic components, including hydroprocessed esters and fatty acids (HEFA) from vegetable oil-containing feedstock, as well as fuel produced from coal, natural gas, or biomass using Fischer-Tropsch (FT) synthesis. In one exemplary embodiment, the term “ultra-low sulfur fuel,” including ultra-low sulfur diesel (ULSD) may be defined by government or industry standard.

The green fuel pump 172 functions to remove the green fuel from the green fuel tank 170 based on commands from the controller 190. The green fuel sensor 174 functions to measure or derive the amount of fuel in the green fuel tank 170 and provide the amount to the controller 190 and/or the pilot via the user interface 192. The green fuel valve 176 is configured to direct the fuel from the green fuel tank 170 to the APU 130 or the mixing apparatus 180 based on commands from the controller 190, as discussed in greater detail below.

The mixing apparatus 180 receives primary fuel from the main fuel tank 160 and green fuel from the green fuel tank 170. The mixing apparatus 180 mixes a first amount of the primary fuel and a second amount of the green fuel on-board the aircraft to provide a mixed fuel at a predetermined primary to green ratio. The mixing apparatus 180 may be any suitable apparatus for mixing and delivering the fuels in a predetermined ratio. In one exemplary embodiment, the mixing apparatus 180 may include metering apparatus and a tank.

During operation, the controller 190 operates the main engine 120 and the APU 130 in one or more modes. Typically, the controller 190 selects a mode for the main engine 120 and a mode for the APU 130 based on considerations discussed below.

In a first main engine mode, the controller 190 commands the fuel sources 150 to provide the main engine 120 with primary fuel from the main fuel tank 160 (e.g., via commands to the pump 162 and valve 166). In a second main engine mode, the controller 109 commands the fuel sources 150 to provide the main engine 120 with mixed fuel from the mixing apparatus 180.

In a first APU (or auxiliary power source) mode, the controller 190 commands the fuel sources 150 to provide the APU 130 with green fuel from the green fuel tank 170 (e.g., via commands to the pump 172 and valve 176). In a second APU (or auxiliary power source) mode, the controller 190 commands the fuel sources 150 to provide the APU 130 with primary fuel from the main fuel tank 160 (e.g., via commands to pump 162 and valves 166).

The controller 190 selects the appropriate mode based on a number of considerations. In one exemplary embodiment, the pilot or operator provides commands for the controller 190 via the user interface 192. As further examples, the controller 190 selects the appropriate mode based on flight status or mode and the fuel levels within the main fuel tank 160 and the green fuel tank 170.

Typically, the controller 190 commands the main engine 120 to operate in the first main engine mode such that the main engine 120 receives and consumes only primary fuel. However, in some situations, the controller 190 commands the main engine 120 to operate in the second main engine mode such that the main engine 120 receives and consumes a mixture of primary fuel and green fuel. In effect, the green fuel supplements the primary fuel to supply the main engine 120. This may be particularly desirable or advantageous during unpredicted flight situations, such as an in-flight diversion, or during situations in which the amount of primary fuel consumed was greater than expected. The controller 190 may anticipate these situations by monitoring the amount of primary fuel remaining in the main fuel tank 160 and the updated expected usage.

Government regulation, technical or operational specifications, or other such requirements may dictate the amount of green fuel that may be used to operate the main engine 120. Such requirements may be expressed as a predetermined or minimum ratio of primary fuel to green fuel. As an example, the predetermined or minimum ratio of primary fuel to green fuel may be 50:50. In other words, at least half of the fuel provided to the main engine 120 must be primary fuel, in one exemplary embodiment. Other ratios may be provided.

As such, during flight, the controller 190 monitors the amount of primary fuel remaining and the anticipated usage of primary fuel to arrive at the desired destination. If the controller 190 determines that primary fuel in the main fuel tank 160 is sufficient to arrive at the destination, the controller 190 continues to operate in the first main engine mode. However, if during flight, the controller 190 determines that the primary fuel in the main fuel tank 160 is insufficient to arrive at the destination, the controller 190 switches operation to the second main engine mode. The controller 190 may immediately transition into the second main engine mode, or the controller 190 may select an appropriate time or location to switch to the second main engine mode such that the amount of fuel in the main fuel tank 160 is sufficient to reach the desired location at the predetermined ratio of primary fuel to green fuel. For example, the controller 190 may select the time or location to switch to the second main engine mode at which the remaining primary fuel is sufficient, considering the 50:50 ratio, to arrive at the desired locations. The controller 190 may also consider a margin of error when determining the appropriate main engine mode. As such, during the transition the second main engine mode, the controller 190 selects and commands a first amount of primary fuel and a second amount of green fuel to the mixing apparatus 180 to result in the predetermined ratio delivered to the main engine 120. In further embodiment, the controller 190 may select the appropriate mode based on location and/or applicable environmental standards. For example, some countries may require lower emissions, and thus additional use of green fuels, as opposed to other countries.

In some embodiments, additional modes may be provided, such as modes that burn a different ratio of primary fuel and green fuel than the predetermined minimum ratio discussed above. Such different ratios may be selected based on different or additional considerations than the second main engine mode discussed above. Other considerations may include fuel efficiencies and pollution issues. For example, the controller 190 may select operation in the second main engine mode to at least partially burn green fuel, which may result in less pollution than burning only primary fuel, or the controller 190 may select operation in a further APU mode in which the APU 130 burns a mixture of primary and green fuels.

Typically, the controller 190 commands the APU 130 to operate in the first APU mode such that the APU 130 receives and consumes green fuel. However, in some situations, the controller 190 commands the APU 130 to operate in the second APU mode such that the APU 130 receives and consumes primary fuel. The controller 190 may command the APU 130 to operate in the second APU mode, for example, when the green fuel from the green fuel tank 170 is low. As such, either mode for operating the APU 130 may be selected, depending on the scenario, including the level of fuel sources, location, and emission requirements.

Accordingly, the controller 190 selects the appropriate main engine mode and APU engine mode to deliver and utilize the appropriate amount, combination, and type of fuel to operate in an improved manner. As discussed below, other exemplary embodiments may use green fuel in other arrangements.

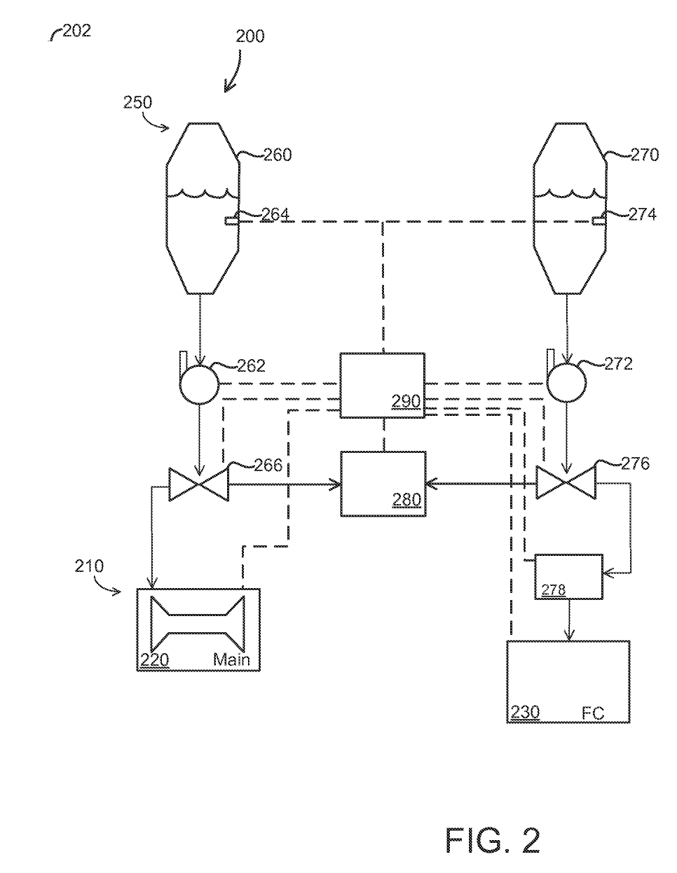

FIG. 2 is a schematic block diagram of an aircraft system 200 according to another exemplary embodiment. Unless otherwise noted, the aircraft system 200 operates similar to the aircraft system 100 discussed above in reference to FIG. 1.

As above, the aircraft system 200 includes one or more power sources 210 and one or more fuel sources 250 housed on an aircraft 202, as well as one or more controllers 290 for operating the power sources 210 and the fuel sources 250 based on predetermined instructions and/or from commands from a pilot or operators via a user interface 292.

In addition to the main engine 220, as above, in this exemplary embodiment, the power sources 210 include a fuel cell 230. Generally, a fuel cell 230 is an energy device that converts chemical energy from a fuel into electricity through a chemical reaction with oxygen or another oxidizing agent. In one exemplary embodiment, such as the embodiment discussed below, hydrogen is the fuel, but other hydrocarbons such as natural gas and alcohols like methanol may also be used. As typically arranged, electrons are drawn from the hydrogen fuel at an anode to a cathode through an external circuit, thereby producing electricity. Any suitable type of fuel cell 230 may be provided, including a proton exchange membrane fuel cell. During operation, the fuel cell 230 may provide electricity to a number of aircraft systems and/or other functions, such as tank inerting or water generation. Although not shown, the system 200 may further include an APU, as discussed above.

As above, the fuel sources 250 include a main fuel tank 260, a green fuel tank 270, and a mixing apparatus 280. The fuel sources 250 may also be considered to include a main fuel pump 262, a main fuel sensor 264, a main fuel valve 266, a green fuel pump 272, a green fuel sensor 274, and a green fuel valve 276 that operate as discussed above. Although not shown, additional pumps, valves, sensors, and the like may be provided for operating the fuel sources 250 according to the functions described below. In this exemplary embodiment, a green fuel processor 278 may also be provided. As discussed in greater detail below, the green fuel processor 278 receives green fuel and functions to generate hydrogen from the green fuel. The fuel processor 278 may generate hydrogen, for example, from any suitable fuel reforming technique, including steam reforming and autothermal reforming.

During operation, the controller 290 operates the main engine 220 in one or more modes. In one exemplary embodiment, the controller 290 operates the fuel cell 230 in a single mode. As such, during operation, the controller 290 commands the green fuel tank 270 (e.g., via the green fuel pump 272 and the green fuel valve 276) to deliver green fuel to the green fuel processor 278. The green fuel processor 278 provides hydrogen fuel to the fuel cell 230 for the generation of electricity. Typically, the controller 290 selects a mode for the main engine 220 based on considerations discussed below.

In a first main engine mode, the controller 290 commands the fuel sources 250 to provide the main engine 220 with primary fuel from the main fuel tank 260 (e.g., via commands to the pump 262 and valve 266). In a second main engine mode, the controller 290 commands the fuel sources 250 to provide the main engine 220 with mixed fuel from the mixing apparatus 280.

Typically, as above, the controller 290 commands the main engine 220 to operate in the first main engine mode such that the main engine 220 receives and consumes only primary fuel. However, in some situations, the controller 290 commands the main engine 220 to operate in the second main engine mode such that the main engine 220 receives and consumes a mixture of primary fuel and green fuel, as discussed above. Accordingly, the controller 290 selects the appropriate main engine mode to deliver and utilize the appropriate amount, combination, and type of fuel to operate in an improved manner.

The main fuel tank (e.g., main fuel tank 160, 260) and the green fuel tank (e.g., green fuel tank 170, 270) may be configured and structured in any suitable manner. In one exemplary embodiment, the main fuel tank and the green fuel tank are configured as dedicated and separate tanks, as depicted in FIGS. 1 and 2. In other words, the main fuel tanks 160, 260 discussed above contain only (e.g., 100%) primary fuel, and the green fuel tanks 170, 270 discussed above contain only (e.g., 100%) green fuel. In this type of arrangement, each fuel tank may be more easily serviced and/or additional total fuel may be provided as compared to conventional fuel systems that only have primary fuel. Additional exemplary arrangements are discussed below.

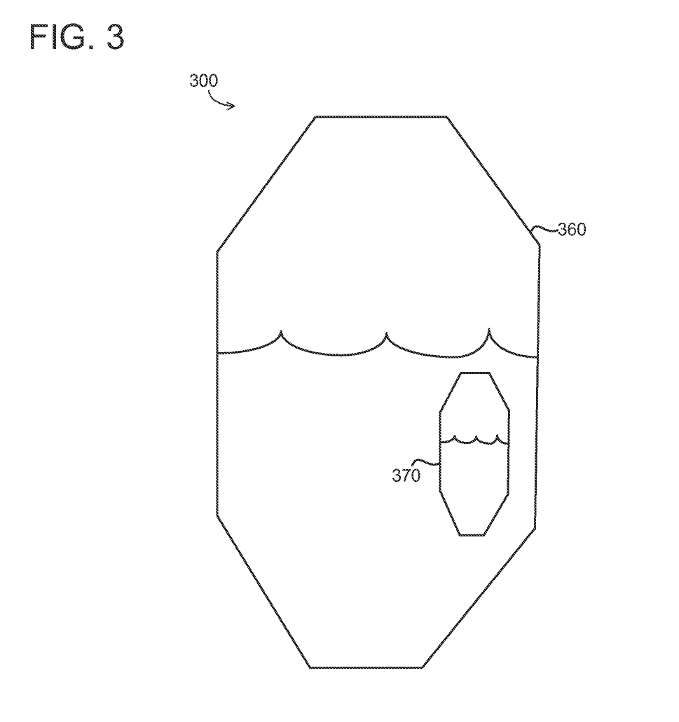

FIG. 3 is a schematic view of a fuel tank assembly 300 according to another exemplary embodiment. The fuel tank assembly 300 includes a main fuel tank 360 and a green fuel tank 370 that function as discussed above.

As shown, in this exemplary embodiment, the green fuel tank 370 is arranged within the main fuel tank 360. Although the main fuel tank 360 contains the green fuel tank 370, tanks 360, 370 are arranged such that the fuels remain separate. However, in this exemplary embodiment, any leaks in the green fuel tank 370 may be contained by the main fuel tank 360 without hazard. Additionally, this arrangement results in a same total volume of fuel and fuel tanks as a conventional arrangement with only main fuel tanks.

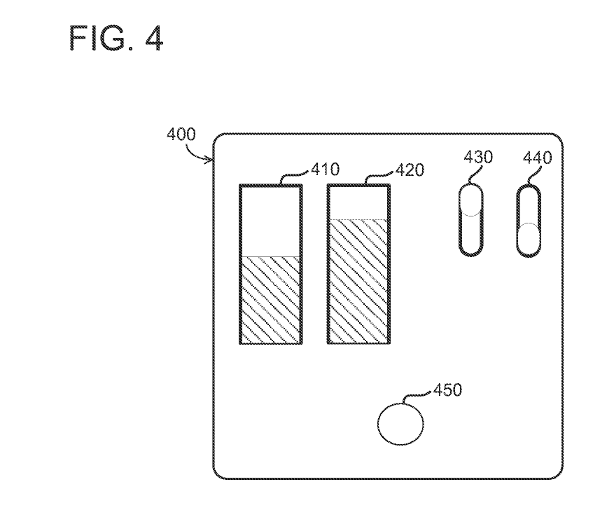

FIG. 4 is a schematic representation of a user interface 400 of an aircraft system according to an exemplary embodiment. As an example, the user interface 400 may be coupled to the controller (e.g., controllers 190. 290) of the systems 100, 200 discussed above. Generally, any suitable control functionality may be provided for the systems 100, 200 with the associated appropriate interaction enabled by the user interface 400. In some exemplary embodiments, the systems 100, 200 may be automatic such that no user input is necessary. In such embodiments, the user interface 400 may be omitted.

In general, the user interface 400 may include a display device, such as a suitably configured liquid crystal display (LCD), plasma, cathode ray tube (CRT), or head-up display, graphical elements. The user interface 400 enables the user to enter data and/or control the various aspects of the systems 100, 200 (FIGS. 1 and 2). For example, the user interface 400 may be formed by interactive graphical elements rendered on a touch screen of the display device. Other user input devices may include a keyboard or keypad, a voice recognition system, a cursor control device, a joystick or knob, or the like.

In the depicted embodiment, the user interface 400 may include visual depictions of a level of fuel 410 in the main fuel tank (e.g., fuel tank 160, 260) and a level of fuel 420 in the green fuel tank (e.g., fuel tank 170, 270). This provides the operator with a current fuel state of the aircraft, and as an example, enables the initiation, continuation, or discontinuation of the system modes discussed above. In particular, the user interface 400 further includes one or more switches 430, 440 that enable selection of one or more of the modes discussed above. As shown, switch 430 enables selection between a first main engine mode in which the main engine receives only primary fuel and a second main engine mode in which the main engine receives a mixture of primary and green fuels. In this embodiment, switch 440 is provided to enable selection between a first APU mode in which the APU receives only green fuel and a second APU mode in which the APU receives only primary fuel. In some embodiments, the user interface 400 includes one or more warning lights 450. As examples, the warning light 450 may inform the operator that one or more of the fuel tanks is getting low and/or that the mode should be switched. Other selections and/or information corresponding to the functions discussed above may be provided.

Accordingly, exemplary embodiments discussed above may include a separate green (or bio-) fuel tank with green fuel for the APU and or fuel cell, while also making the green fuel available for the main engines to use. As an example, green fuel may include less sulfur than primary fuel. This allows the APU and or fuel cell to have the advantages of reduced emissions and no sulfur and alleviates the issue that the unused green fuel from a flight as dead weight that was otherwise carried around just for the APU and fuel cell. In the case where the main engines need additional fuel, the green tank may be drained into the normal main engine fuel tanks. As an example, current certification requirements would require that the concentration of the main fuel tanks be maintained below 50% green fuel, which may be managed by a controller or other type of metering device. Operationally, aircraft are typically required to maintain certain reserves of fuel for emergencies like diversion to new airports. Generally, the green fuel in the green fuel tank would not need to be mixed into the main tanks to be included in the reserve calculation. As such, draining of the green fuel tank would only need to be done in extreme situations when the fuel reserves were down to very low levels, e.g., approaching the 50% green fuel concentration after mixing. This would allow many flights worth of green fuel to be carried with no penalty for the green fuel tank or green fuel weight. This would reduce the need for green fuel at all airports and the extra servicing of the green fuel tank for each flight.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An aircraft system, comprising:
a main fuel tank configured to house primary fuel;
a green fuel tank configured to house green fuel;
a mixing apparatus coupled to the main fuel tank and the green fuel tank, the mixing apparatus configured to mix the primary fuel and the green fuel to result in a predetermined ratio of mixed fuel; and
a controller configured to selectively command a first amount of primary fuel from the main fuel tank and a second amount of green fuel from the green fuel tank to result in the predetermined ratio of mixed fuel;
a main aircraft engine coupled to the controller, the main fuel tank, and the mixing apparatus, wherein the main aircraft engine is configured to operate, in a first main engine mode, with the primary fuel from the main fuel tank and to operate, in a second main engine mode, with the mixed fuel from the mixing apparatus based on commands from the controller; and
an auxiliary power source coupled to the controller and the green fuel tank, wherein the auxiliary power source is configured to operate with at least a portion of the green fuel from the green fuel tank based on commands from the controller.

2. The aircraft system of claim 1,
further comprising a green fuel processor coupled to the green fuel tank and the auxiliary power source, wherein the green fuel processor is configured to receive the green fuel from the green fuel tank and to process the green fuel into hydrogen, and
wherein the auxiliary power source is a fuel cell configured to operate with the hydrogen of the green fuel.

3. The aircraft system of claim 1,
wherein the auxiliary power source is auxiliary power unit (APU).

4. The aircraft system of claim 3, wherein the APU is additionally coupled to the main fuel tank and configured to operate, in a first APU mode, with the green fuel from the green fuel tank and to operate, in a second APU mode, with the primary fuel from the main fuel tank.

5. The aircraft system of claim 1, wherein the controller is configured to selectively operate the main aircraft engine in the first main engine mode and in the second engine mode.

6. The aircraft system of claim 5, further comprising a main fuel sensor coupled to the controller and configured to measure a first level of fuel in the main fuel tank, the controller configured to selectively command the first amount and the second amount based on the first level of fuel in the main fuel tank.

7. The aircraft system of claim 6, wherein the controller is configured to selectively command the first amount and the second amount to result in the predetermined ratio of approximately 50:50.

8. The aircraft system of claim 1, wherein the main fuel tank and the green fuel tank are separate fuel tanks.

9. The aircraft system of claim 1, wherein the green fuel tank is housed within the main fuel tank and configured to house the green fuel while maintaining separation between the green fuel and the primary fuel.

10. An aircraft fuel system, comprising:
a main fuel tank configured to house primary fuel;
a green fuel tank configured to house green fuel;
a mixing apparatus coupled to the main fuel tank and the green fuel tank, the mixing apparatus configured to mix the primary fuel and the green fuel to result in a predetermined ratio of mixed fuel; and
a controller configured to selectively command a first amount of primary fuel from the main fuel tank and a second amount of green fuel from the green fuel tank to result in the predetermined ratio of mixed fuel.

11. The aircraft fuel system of claim 10,
wherein the controller is configured to selectively command the mixed fuel from the mixing apparatus to a main aircraft engine.

12. The aircraft fuel system of claim 10, further comprising a green fuel processor coupled to the controller and the green fuel tank and configured to generate hydrogen from the green fuel,
wherein the controller is configured to selectively command the green fuel from the green fuel tank to the green fuel processor and to selectively command the hydrogen from the green fuel processor to an aircraft fuel cell.

13. The aircraft fuel system of claim 10,
wherein the controller is configured to selectively command the green fuel from the green fuel tank to an aircraft auxiliary power unit.

14. The aircraft fuel system of claim 13,
wherein the controller is configured to selectively command the primary fuel from the main fuel tank to the aircraft auxiliary power unit.

15. The aircraft fuel system of claim 10, further comprising a primary fuel sensor coupled to the controller and configured to measure a first level of fuel in the main fuel tank, the controller configured to selectively command the first amount and the second amount based on the first level of fuel in the main fuel tank.

16. The aircraft fuel system of claim 10, wherein the controller is configured to selectively command the first amount and the second amount to result in the predetermined ratio of approximately 50:50.

17. The aircraft fuel system of claim 10, wherein the main fuel tank and the green fuel tank are separate fuel tanks.

18. The aircraft fuel system of claim 10, wherein the green fuel tank is housed within the main fuel tank and configured to house the green fuel while maintaining separation between the green fuel and the primary fuel.

19. The aircraft fuel system of claim 10, wherein the primary fuel is a kerosene-based fuel.

20. The aircraft fuel system of claim 19, wherein the green fuel is a biofuel.
